(19) United States
(12) Patent Application Publication
(10) Pub. No.: US 2022/0303354 A1
(43) Pub. Date: Sep. 22, 2022

(54) SERVICE PROVIDING SYSTEM, INFORMATION PROCESSING METHOD, AND RECORDING MEDIUM

(71) Applicant: Rina TAKAHASHI, Kanagawa (JP)

(72) Inventor: Rina TAKAHASHI, Kanagawa (JP)

(73) Assignee: Ricoh Company, Ltd., Tokyo (JP)

(21) Appl. No.: 17/653,306

(22) Filed: Mar. 3, 2022

(30) Foreign Application Priority Data
Mar. 18, 2021 (JP) 2021-045235

(51) Int. Cl. H04L 67/51; G06F 9/50; G06F 9/48

(52) U.S. Cl. CPC H04L 67/51; G06F 9/5077; G06F 9/4881

(57) ABSTRACT

A service providing system configured to manage information relating to an application that is available for use to a user in a management unit in which the user is registered, the service providing system including circuitry; and a memory storing computer-executable instructions that cause the circuitry to execute creating a setting of an application that is available for use in a second management unit, based on a setting of the application that is also available for use in a first management unit in which the user is already registered, in response to a registration request to register the user in the second management unit.

### CROSS-REFERENCE TO RELATED APPLICATION

The present application is based on and claims priority under 35 U.S.C. § 119 to Japanese Patent Application No. 2021-045235, filed on Mar. 18, 2021, the contents of which are incorporated herein by reference in their entirety.

### BACKGROUND OF THE INVENTION

### 1. Field of the Invention

The present invention relates to a service providing system, an information processing method, and a recording medium.

### 2. Description of the Related Art

When a company uses a service by software or a device, etc., by dividing the scope of providing the service into managing units referred to as tenants, and making contracts according to the division, the service can be used flexibly according to the needs and budgets of the organizations. For such services, it is necessary to appropriately manage setting information relating to the service provider, the tenant, etc., for each tenant. For example, when the service provider is changed, with regard to the attribute information of the service provider, a technique for appropriately managing the information that needs to be transferred and the information that is unnecessary, is disclosed (see Patent Document 1).
Patent Document 1: Japanese Unexamined Patent Application Publication No. 2017-215782

### SUMMARY OF THE INVENTION

According to one aspect of the present invention, there is provided a service providing system configured to manage information relating to an application that is available for use to a user in a management unit in which the user is registered, the service providing system including circuitry; and a memory storing computer-executable instructions that cause the circuitry to execute creating a setting of an application that is available for use in a second management unit, based on a setting of the application that is also available for use in a first management unit in which the user is already registered, in response to a registration request to register the user in the second management unit.

### BRIEF DESCRIPTION OF THE DRAWINGS

FIG. 1 is an example of a system configuration diagram of a service providing system according to a first embodiment of the present invention;

FIG. 2 illustrates a system image of adding a user to a tenant according to the first embodiment of the present invention;

FIG. 3 is an example of a flow chart for adding a user to a tenant according to the first embodiment of the present invention;

FIG. 4 illustrates an example of a setting transfer confirmation dialog according to the first embodiment of the present invention;

FIG. 5 illustrates an example of the hardware configuration of a device (image forming apparatus) according to the first embodiment of the present invention;

FIG. 6 illustrates an example of hardware configuration of an information processing apparatus and a PC terminal according to the first embodiment of the present invention;

FIG. 7 is an example of a diagram illustrating the functional configuration of a service providing system according to the first embodiment of the present invention;

FIG. 8 illustrates an example of application information according to the first embodiment of the present invention;

FIG. 9 illustrates an example of an application setting screen according to the first embodiment of the present invention;

FIG. 10 illustrates an example of user information according to the first embodiment of the present invention;

FIG. 11 illustrates an example of tenant information according to the first embodiment of the present invention;

FIG. 12 is an example of a sequence diagram illustrating an example of an application setting transfer process when adding a user to a tenant according to the first embodiment of the present invention;

FIG. 13 is an example of a sequence diagram illustrating an example of an application setting transfer process when a user adds a tenant according to the first embodiment of the present invention;

FIG. 14 is an example of a sequence diagram illustrating an example of a process when an application is added in an environment in which the user belongs to multiple tenants according to the first embodiment of the present invention;

FIG. 15 is an example of a sequence diagram illustrating an example of a process when an application is activated without making a setting in the setting site according to the first embodiment of the present invention;

FIG. 16 illustrates an example of a system image for preparing template information according to a second embodiment of the present invention;

FIG. 17 illustrates an example of template information according to the second embodiment of the present invention;

FIG. 18 is an example of a flow chart of application setting transfer using template information according to the second embodiment of the present invention;

FIG. 19 is an example of a diagram illustrating the functional configuration of a service providing system according to the second embodiment of the present invention; and

FIG. 20 is an example of a sequence diagram illustrating an example of an application setting transfer process when adding a tenant by using template information according to the second embodiment of the present invention.

### DESCRIPTION OF THE EMBODIMENTS

A service provided on a per tenant basis not only requires the management of attribute information of the service provider, but also requires the management of the settings of the tenant and the application used in the service. With respect to the settings of the application, in addition to managing the settings specific to each tenant, it is also necessary to manage the settings specific to each user belonging to the tenant.

However, in the conventional technology, it is not possible to transfer the settings of the application in one tenant to another tenant, so when the user uses the same application in another tenant, there has been a problem that the user needs to recreate the settings for the application from the beginning.

A problem to be addressed by an embodiment of the present invention is to create settings of an application that is used in a second managing unit, based on the settings of the application that is available for use in a first managing unit in which the user is already registered.

Hereinafter, as an example of an embodiment of the present invention, a service providing system and an information processing method performed by the service providing system (an information processing apparatus) will be described with reference to the drawings.

### First Embodiment

### <System Configuration>

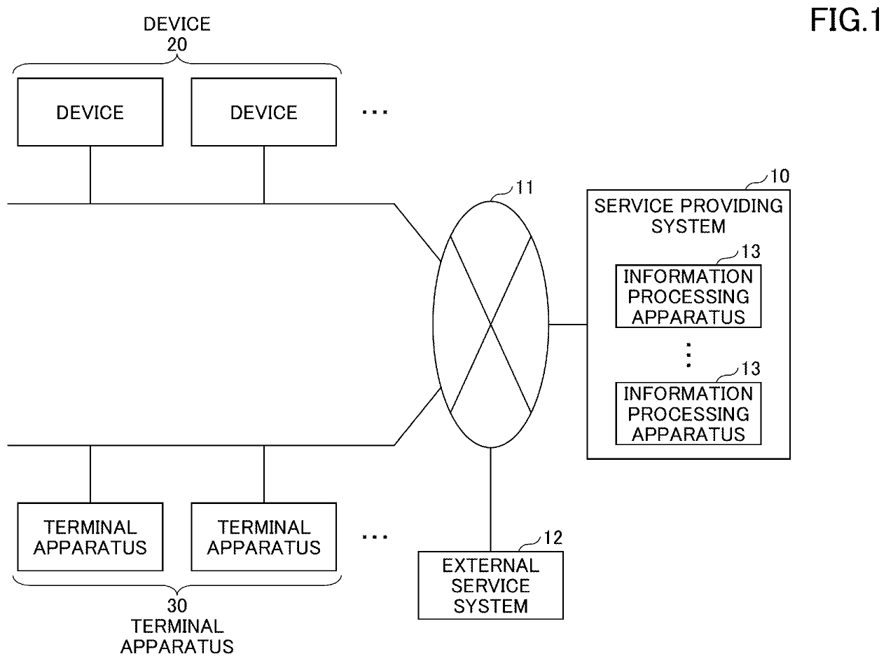

FIG. 1 is a diagram illustrating an example of a system configuration of a service providing system according to the present embodiment. A service providing system 10 is communicatively connected to a device 20, a terminal apparatus 30, and an external service system 12 via a network 11. The service providing system 10 may be configured by one or more servers or information processing apparatuses 13.

The device 20 may be, for example, an image forming apparatus such as a Multifunction Peripheral (MFP), a personal computer (PC), a projector, an electronic blackboard, a video conference terminal, a digital camera, or the like. The device 20 is connected to the network 11. The user may use the device 20 to use various services provided by the service providing system 10.

The terminal apparatus 30 may be, for example, a desktop PC, a notebook PC, a smartphone, a tablet terminal, or the like used by an administrator or a user. The terminal apparatus 30 is connected to the network 11. The administrator or the user may operate the terminal apparatus 30 to use various services provided by the service providing system 10, and to make settings of an application.

The external service system 12 provides various services by executing an application via the network 11. For example, in the storage service, data is saved or read by executing an application. The term “external” of the external service system 12 refers to a system that is separate from the service providing system 10.

### <Operation Overview>

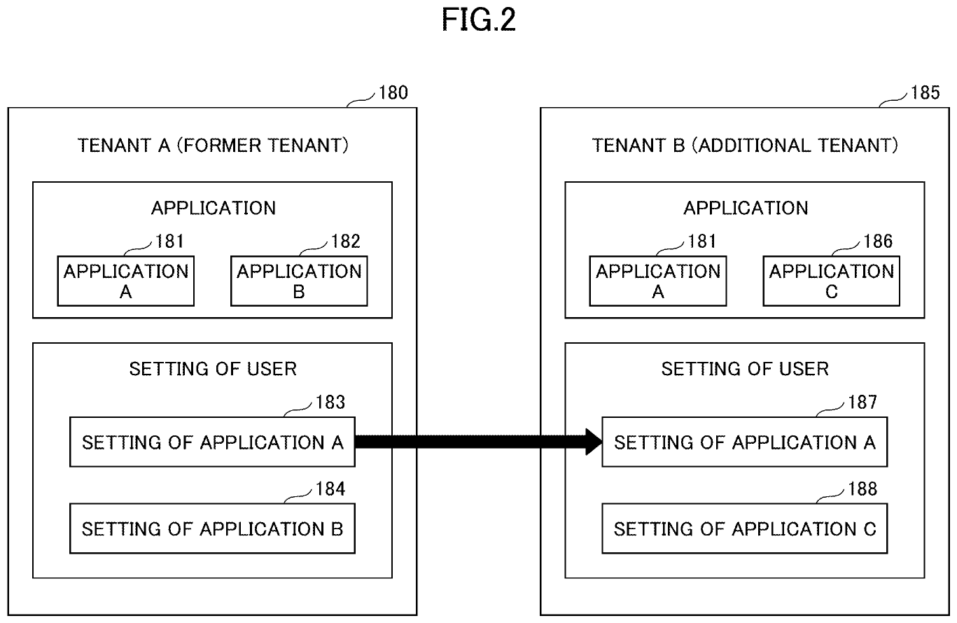

An outline of the operation performed by the service providing system according to the present embodiment will be described with reference to FIG. 2. The system provides services to a managing unit referred to as a tenant, and a tenant A and a tenant B may be respectively referred to as, for example, a first organization and a second organization, or a first managing unit and a second managing unit. A tenant means information indicating a plurality of customers that share the same software, i.e., an organization that may be a company or a department that is an assembly of customers. An application contracted by a tenant can be used by each user or the device 20 in the tenant, and the tenant administrator can grant the use right to use multiple software instances (i.e., applications or a package of multiple applications) in the system to a user or the device 20 belonging to the tenant. A tenant may be a managing unit in which at least one of users or the devices 20 are grouped, and a tenant may be an assembly of users or the devices 20 belonging to the same organization or an assembly of users or the devices 20 residing in a certain region. For example, when the tenant administrator purchases a license for an application, a new application is registered for each tenant, and the user or the device 20 belonging to the tenant can use the application. The tenant administrator may also selectively allow or limit the use of an application to users and the devices 20 belonging to the tenant. Further, multiple tenants may be registered in a single organization, and multiple tenants or groups may be registered in each tenant. Tenants and groups are examples of managing units managed by the service providing system. First, a user who belongs to a tenant A 180, which is a former tenant, is invited to an additional tenant, i.e., a tenant B 185. At this time, an initial setting is made to the application, so that the user can use the application registered in the tenant B 185. An example of an application is an application that is executed on an image forming apparatus such as an MFP. The user can log in from the MFP as a user of each tenant, to use the application of the tenant to which the user has logged in. Subsequently, applications may be abbreviated as apps. An application is a program executed by the device 20, the service providing system 10, the external service system 12, or a combination thereof in order for a user to receive a service. That is, a service includes various functions provided from the application from the service providing system 10 to the device 20 or the terminal apparatus 30. A program executed in cooperation by the terminal apparatus 30 and the information processing apparatus 13 may be referred to as a web application. Applications also include applications that are installed and used in electronic devices. The device 20, such as the image forming apparatus, can individually execute the function of an application. However, at a predetermined timing, such as when the application is activated, when the application function is executed, or when the device 20 is activated, the validity of the license may be inquired to the information processing apparatus 13 that manages the license, and only when the license is determined to be valid in the information processing apparatus 13, the functions of the application may be executed.

An application A 181 and an application B 182 are registered in the tenant A 180, and the application A 181 and an application C 186 are registered in a tenant B 185. The application A 181 is registered in both the tenant A 180 and the tenant B 185. Therefore, in a setting 183 of the application A used by the user in the tenant A 180, the items that the user can set can be copied to a setting 187 of the application A in the tenant B 185, so that the setting can be transferred from the tenant A 180 to the tenant B 185 and used in the tenant B 185. Accordingly, the user does not need to make the setting 187 of the application A in the tenant B 185 from the beginning. The setting items that can be set by the user may differ depending on the function provided by the application. If the application is related to the MFP scanning process, the setting items include, for example, the path of the initial folder for saving the MFP scan results, the default value of the file name to be saved, and the parameter setting such as the resolution at the time of scan. If the application is related to the MFP printing process, the setting items include, for example, the path of the initial folder for storing the file to be printed by the MFP, the setting of color/monochrome, the setting of parameters such as the paper size, etc. The setting items for each of these applications and the setting values for each of the setting items may be referred to as an application setting in the following.

The application can download the file to be printed or upload the scan results from or to an external service system such as cloud storage. Setting items can include information to specify which cloud storage is to be used among multiple cloud storages used by each application, account information to access each cloud storage, and authentication information such as a password or an access token.

There are two types of setting items: items that can be used and edited with respect to each user, and items that are commonly used with respect to multiple users within the tenant and that can be edited by the administrator.

As described above, not only when a user is invited to a new tenant, but also when a new application is added to the tenant B and the application is already present in the tenant A, the settings can be transferred in the same manner. Further, if both the tenant A and the tenant B are both continuously used, each time a change is made in the setting of one tenant, the setting in the other tenant may be changed in synchronization with this change. This simplifies the management of application settings.

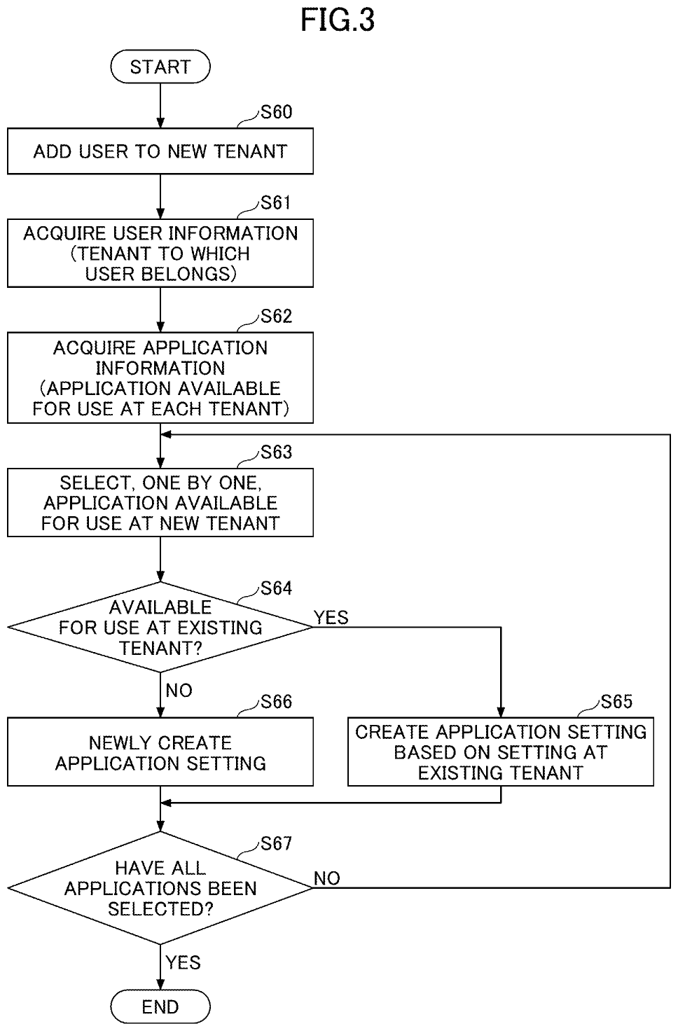

Next, a process flow performed by the service providing system according to the present embodiment will be described with reference to FIG. 3.

S60: A tenant administrator adds a user to a new tenant by using the terminal apparatus 30.

S61: An authentication managing unit 51 of the service providing system 10 acquires information relating to which tenant the added user belongs to.

S62: An application managing unit 41 of the service providing system 10 acquires information relating to applications available for use to each tenant.

S63: The application managing unit 41 selects applications available for use to the new tenant one by one. If the availability of use of applications is set for each user belonging to the tenant, only the applications that are available for use to the user who is newly added to the tenant may be selected.

S64: The application managing unit 41 confirms whether the selected application is available for use to the existing tenant. If the availability for use of the application is set for each user belonging to a tenant, it may be possible to confirm whether the selected application is available for use to the user who is to be newly added to a tenant, at the existing tenant. If available (YES), the process proceeds to S65 and if not (NO), the process proceeds to S66.

S65: The application managing unit 41 creates a setting of the application of the new tenant, based on the application setting at the existing tenant.

S66: The application managing unit 41 newly creates an application setting for the new tenant.

S67: If the application managing unit 41 has selected all applications (YES), the process is ended, and if there is an application that has not yet been selected (NO), the process proceeds to S63.

This description assumes that the system automatically transfers the existing tenant's application setting to create the new tenant's application setting. However, it may be possible to set whether the application setting can be transferred by the tenant administrator or the like, by accessing the service providing system 10 via the terminal apparatus 30. By allowing or prohibiting the transfer of settings at both the transfer source and the transfer destination, it is possible to expand the range of choices in operations. For example, if there is a tenant-specific setting item, the transfer of the setting value may be prohibited at the transfer source or the transfer destination, and if there is a portion to be changed for each tenant, the transfer may be set to be allowed at the transfer source or the transfer destination. The settings may be made on a per application basis or may be selected for each setting item of each application. If a prohibition setting can be made, the transfer may be allowed only when the transfer is allowed at both the transfer source and the transfer destination. If the transfer is set for each setting item, the transfer may be allowed only for the setting item that is allowed at both the transfer source and the transfer destination.

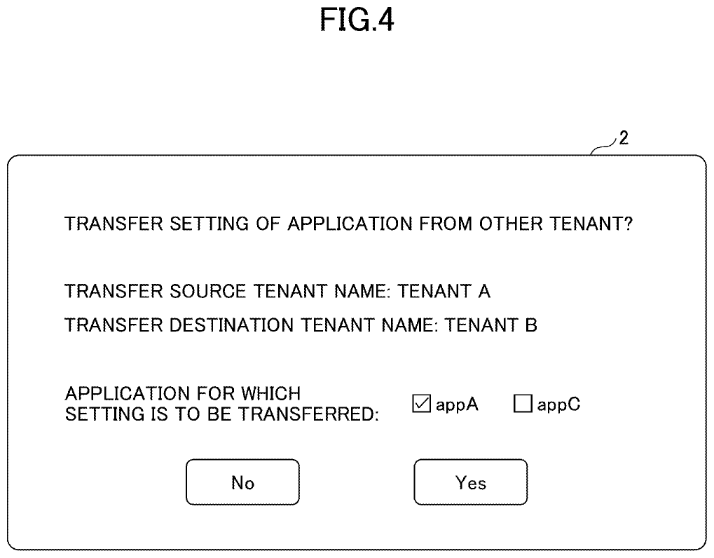

In addition to allowing the transfer setting for each tenant, it is also possible to select whether to transfer the setting for each user. For example, after a user is registered to a tenant, by sending an e-mail including a link to a setting site (website) to the user, the user can access the setting site to select whether the setting is to be transferred. Alternatively, for example, after a user is registered to a tenant, a dialog may be displayed when the user logs in to the service providing system 10 for the first time (when the login to the service providing system 10 is accepted for the first time). This allows the user to access the setting site and select whether the setting is to be transferred. Whether the user has logged in for the first time can be detected, for example, by storing information relating to whether the user has previously logged in, for each user registered in the tenant, and then referring to the information after the user logs in. Further, the setting may not be changed from the initial value until the user selects whether the setting is to be transferred, but at the timing when the user makes the selection, the setting may be overwritten to the transferred setting. Alternatively, when the application is executed in a state where it has not been selected as to whether the setting is to be transferred, a dialog may be displayed on a screen on which the application is operating, to allow the user to select whether to transfer the setting. FIG. 4 illustrates an example of a setting transfer confirmation dialog displayed to the user. Here, appA and appC are displayed as applications for which the setting can be transferred from the tenant A to the tenant B, enabling a selection of whether to transfer the setting for each application.

### <Device>

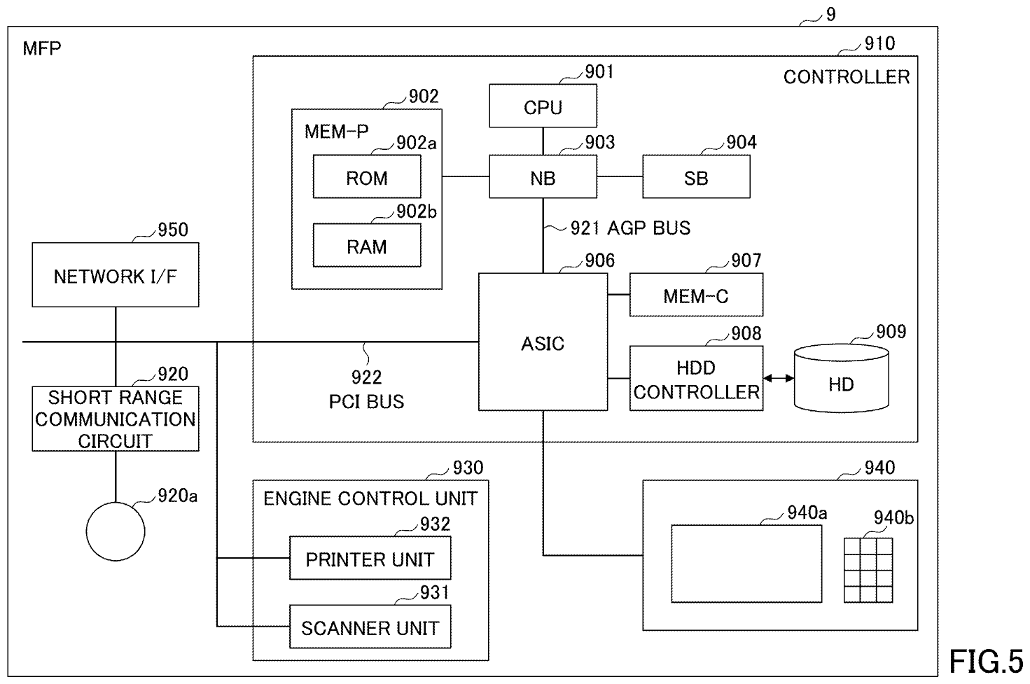

FIG. 5 is a hardware configuration diagram of an image forming apparatus (an MFP 9) that is an example of the device 20. As illustrated in FIG. 5, the MFP 9 includes a controller 910, a short range communication circuit 920, an engine control unit 930, an operation panel 940, and a network interface (I/F) 950. The operation panel 940 includes a panel display unit 940a for receiving input from a user and a numeric pad 940b for receiving input from a user. Among these, the controller 910 includes a central processing unit (CPU) 901, a system memory (MEM-P) 902, a north bridge (NB) 903, a south bridge (SB) 904, an Application Specific Integrated Circuit (ASIC) 906, a local memory (MEM-C) 907 that is a storage unit, a hard disk drive (HDD) controller 908, and a hard disk (HD) 909 that is a storage unit, which are the main part of the computer, and the NB 903 and the ASIC 906 are connected by an Accelerated Graphics Port (AGP) bus 921.

Among these, the CPU 901 is a control unit that performs overall control of the MFP 9. The NB 903 is a bridge for connecting the CPU 901 to the MEM-P 902, the SB 904, and the AGP bus 921, and includes a memory controller for controlling reading and writing from and to the MEM-P 902, a Peripheral Component Interconnect (PCI) master, and an AGP target.

The MEM-P 902 includes a read-only memory (ROM) 902a, which is a memory for storing programs and data by which each function of the controller 910 is implemented, and a random access memory (RAM) 902b, which is used for loading programs or data and is used as a rendering memory when performing memory printing, and the like. The program stored in the RAM 902b may be configured to be provided by being recorded in a computer-readable recording medium such as a compact disk read-only memory (CD-ROM), a CD recordable (CD-R), or a digital versatile disc (DVD) in a file in an installable format or an executable format.

The SB 904 is a bridge for connecting the NB903 to PCI devices and peripheral devices. The ASIC 906 is an integrated circuit (IC) for image processing applications having hardware elements for image processing and has the role of a bridge connecting the AGP bus 921, the PCI bus 922, the HDD controller 908, and the MEM-C907. The ASIC 906 includes a PCI target and an AGP master, an arbiter (ARB) that forms the core of the ASIC 906, a memory controller that controls the MEM-C907, a plurality of Direct Memory Access Controllers (DMACs) that rotates image data by hardware logic, and the like, and a PCI unit that performs data transfer between a scanner unit 931 and a printer unit 932 via the PCI bus 922. An interface of a Universal Serial Bus (USB) or the Institute of Electronic and Electronic Engineers 1394 (IEEE 1394) may be connected to the ASIC 906.

### <Terminal Apparatus>

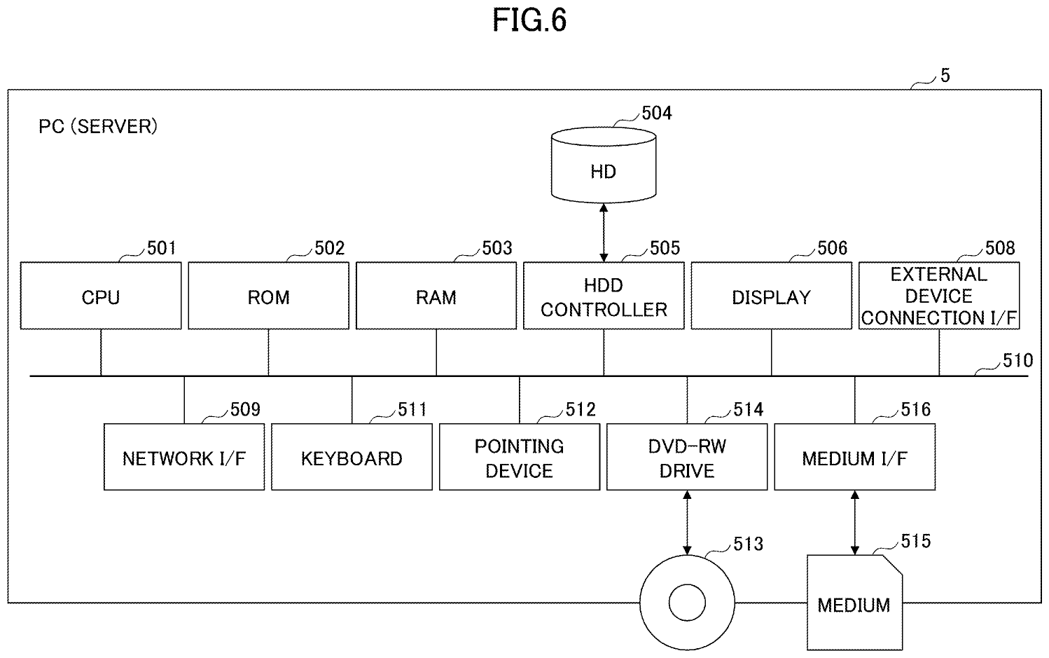

FIG. 6 is a hardware configuration diagram illustrating a PC (server) 5 that is an example of the service providing system 10, the information processing apparatus 13, and the terminal apparatus 30. As illustrated in FIG. 6, the PC (server) 5 is constructed by a computer and includes a CPU 501, a ROM 502, a RAM 503, a HD 504, a HDD controller 505, a display 506, an external device connection I/F 508, a network I/F 509, a bus line 510, a keyboard 511, a pointing device 512, a Digital Versatile Disk Rewritable (DVD-RW) drive 514, and a medium I/F 516.

Among these, the CPU 501 controls the overall operations of the service providing system 10 and the terminal apparatus 30. The ROM 502 stores a program used to drive the CPU 501, such as an Initial Program Loader (IPL). The RAM 503 is used as the work area of the CPU 501. The HD 504 stores various kinds of data such as a program. The HDD controller 505 controls the reading or writing of various kinds of data from and to the HD 504 according to the control of the CPU 501. The display 506 displays various kinds of information such as cursors, menus, windows, characters, or images. The external device connection I/F 508 is an interface for connecting various external devices. In this case, the external device may be, for example, a USB memory or a printer. The network I/F 509 is an interface for performing data communication by using network N2. The bus line 510 is an address bus, a data bus, or the like for electrically connecting components such as the CPU 501 illustrated in FIG. 6.

The keyboard 511 is a type of input means with a plurality of keys used for inputs such as characters, numbers, or various instructions. The pointing device 512 is a type of input means for selecting and executing various instructions, selecting a processing target, moving a cursor, and the like. The DVD-RW drive 514 controls the reading or writing of various kinds of data from and to the DVD-RW 513 as an example of a removable recording medium. The DVD-RW drive 514 is not limited to the DVD-RW but may be with respect to a Digital Versatile Disc Recordable (DVD-R) or the like. The medium I/F 516 controls the reading or writing (storage) of data from or to a recording medium 515, such as a flash memory.

### <Functions>

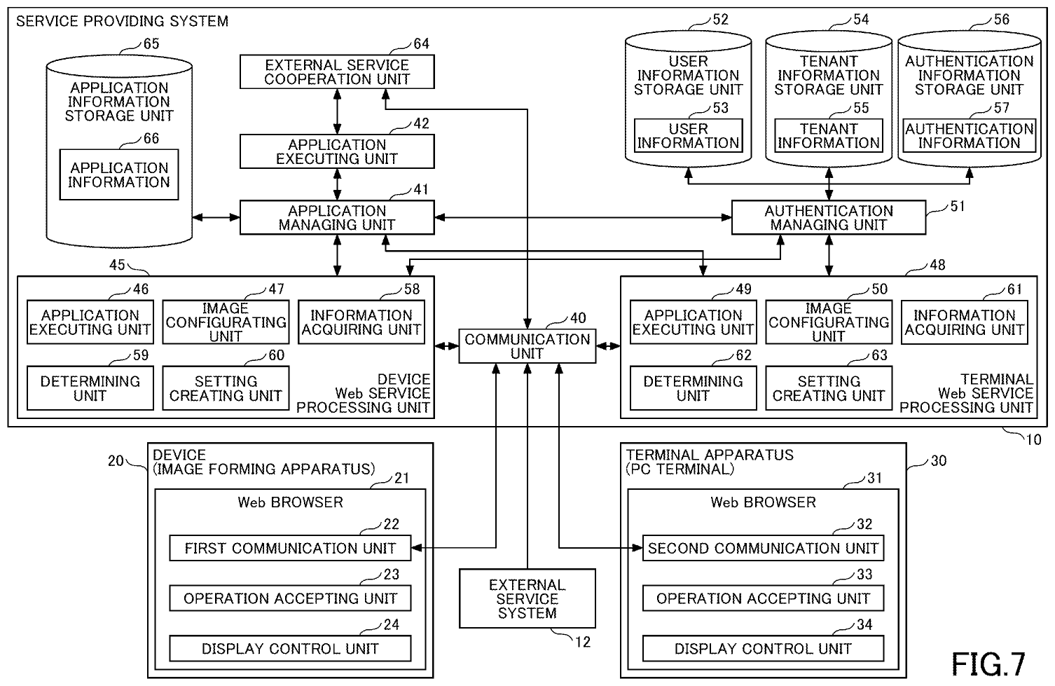

Next, the functional configuration of the service providing system 10 according to the present embodiment will be described with reference to FIG. 7. FIG. 7 is a diagram illustrating an example of a functional configuration of the service providing system 10 according to the present embodiment.

### <<Service Providing System>>

The service providing system 10 includes a communication unit 40, an application managing unit 41, an application executing unit 42, a device web service processing unit 45, a terminal web service processing unit 48, an application information storage unit 65, an authentication managing unit 51, a user information storage unit 52, a tenant information storage unit 54, an authentication information storage unit 56, and an external service cooperation unit 64. Each of these functional units is a function or means implemented when the CPU 501 executes instructions included in one or more programs installed in the service providing system 10.

The communication unit 40 transmits and receives various kinds of information with the device 20, the terminal apparatus 30, and the external service system 12. According to the present embodiment, the communication unit 40 primarily transmits and receives information relating to the setting of the application.

The application managing unit 41 manages the setting of various applications in order to manage the applications executed by the device 20 and stores the application settings as application information 66 in an application information storage unit 65. The application managing unit 41 accepts a change or an acquisition request with respect to the setting or the like of the application, from the terminal apparatus 30. Further, when an application execution is instructed from the device 20 to the application managing unit 41, the setting of the application information and the setting from the device 20 are combined and a request is made to the application executing unit 42. The setting from the device 20 specified at this time is the last value specified by the user, and, therefore, this value is used preferentially.

The application executing unit 42 executes the processing based on the request from the application managing unit 41 and the setting of the application information. Further, the application executing unit 42 transmits and receives files to and from an external storage service via the external service cooperation unit 64.

The external service cooperation unit 64 makes a processing request to the external service in accordance with a service request received from the application executing unit 42.

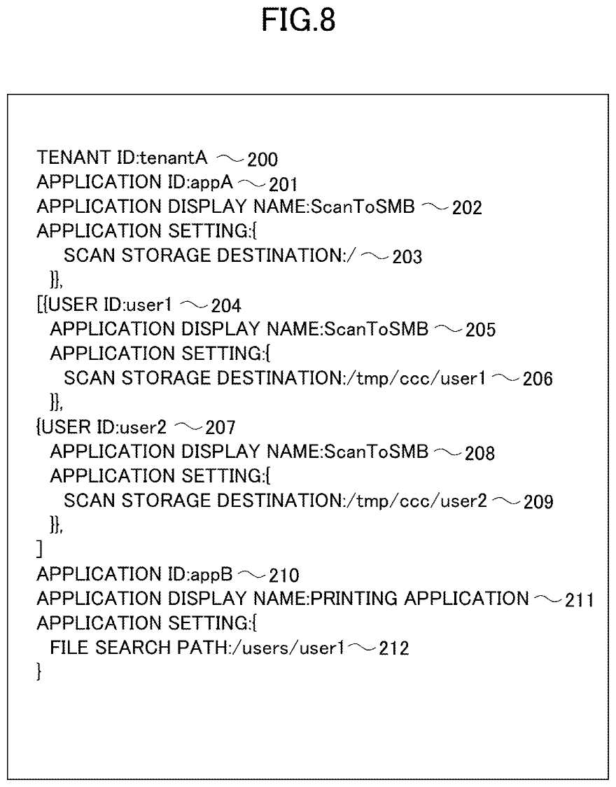

The application information storage unit 65 stores the application information 66. The application information is information relating to an application that is available for use to a user or the device 20 belonging to a tenant, and can be managed for each tenant. FIG. 8 illustrates an example of application information of the tenant A. The application information includes the tenant ID, which is the information for identifying the tenant, the application name, which is the information for identifying the application available for use to the user or the device 20 belonging to the tenant, and the application setting, which is the setting for each application. The application information may include information that limits the user or the device 20 that can use the application from among the users or the devices 20 belonging to the tenant, for each application. For example, the application information may include a user ID or a device ID for which the use of each application is allowed or prohibited.

As an example, in FIG. 8, for the tenant A, tenantA is set as a tenant ID 200, and two applications, for which application IDs 201 and 210 are appA and appB, respectively, are registered. The application appA corresponds to an individual application for which a value is set for each user. The application appB does not have a setting for each user, but is a shared application that is commonly used in the tenant. In the setting of appA, a setting value or an initial value is set for each user. For the user 1 and the user 2, values of user IDs 204 and 207, application display names 205 and 208, and scan storage destinations 206 and 209 are stored, respectively. On the other hand, in the setting of appB, there is no setting value per user, but there is only one setting value as a tenant, and an application display name 211 and the value of a file search path 212 are stored.

Referring back to FIG. 7, the device web service processing unit 45 includes an application executing unit 46, an image configurating unit 47, an information acquiring unit 58, a determining unit 59, and a setting creating unit 60. The application executing unit 46 displays the application information 66 acquired from the application managing unit 41 to the user, and requests the device 20 and the application managing unit 41 to execute the application based based on the user's setting. When the application is related to a printing process, the application executing unit 46 requests the device 20 (the image forming apparatus) to print the image to be acquired from the application managing unit 41. When the application is related to the scan processing, the application executing unit 46 requests the device 20 (the image forming apparatus) to read an image, and the result is transmitted to the application managing unit 41. As subsequent processing, for example, execution of a file transfer to an external service is requested. The image configurating unit 47 displays an application screen for the user to make a selection, a setting value, or the like. The information acquiring unit 58 acquires information such as the application information 66, user information 53, and tenant information 55. The determining unit 59 makes a determination relating to the transfer of the application setting. The setting creating unit 60 performs the creation of the application setting.

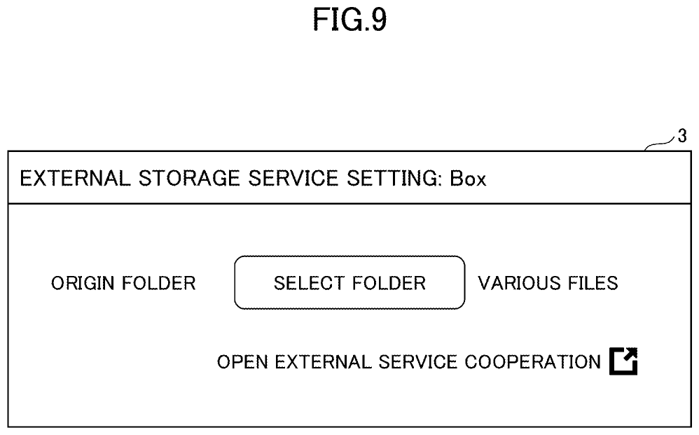

The terminal web service processing unit 48 includes an application executing unit 49, an image configurating unit 50, an information acquiring unit 61, a determining unit 62, and a setting creating unit 63. The application executing unit 49 requests the application managing unit 41 to change the default value and the like, based on input from the user, in order to execute the application for which the application setting is to be made. The image configurating unit 50 displays, to the user, the parameters necessary for setting the application and displays a screen for receiving input. FIG. 9 illustrates an example of a setting screen of an application for which the user is to make application settings. This application uses an external storage service, and a setting screen 3 of an application for downloading a file from a storage service or an application for uploading a file to the storage service is displayed. Note that, with respect to which storage service the application is to use, the storage service may be set at the time of application development as a function of the application, or may be set by having a user select a storage service from among a plurality of storage services. In the case of an application for downloading a file, a file in a folder specified as the “origin folder” selected by the user, is displayed at the time of application activation, and can be selected as the file to be downloaded. If the folder where the file to be downloaded exists is predetermined, by setting the folder as the origin folder in advance, the convenience can be improved. In the case of an application for uploading a file, a folder that exists in a folder specified as the “origin folder” selected by the user, is displayed at the time of application activation, and can be selected as the folder to be the upload destination of the file. That is, the origin folder is the first folder to be referenced when the application is activated. Thus, it is possible to select a folder at the upper layer of the origin folder or the folder at the lower layer of the origin folder, depending on the operation of the user at the application screen. This allows a file and a folder stored in the selected folder, to be displayed in a selectable manner as the printing target or the destination of the scan result.

Referring back to FIG. 7, the information acquiring unit 61 acquires information such as the application information 66, the user information 53, the tenant information 55, and the like. The determining unit 62 makes a determination relating to the transfer of the application setting. The setting creating unit 63 performs the creation of the application setting.

The authentication managing unit 51 acquires and updates the user information 53 and the tenant information 55 respectively stored in the user information storage unit 52 and the tenant information storage unit 54, stores the authentication information 57 in the authentication information storage unit 56, and manages the login and access limitation of a user, a device, and the like. When the authentication information 57 is requested from the application managing unit 41 for the purpose of displaying a personal setting or for using an external service, the authentication managing unit 51 executes authentication and provides the authentication information. For example, when a login request including a tenant ID and a password is received from the device 20, the authentication managing unit 51 may perform authentication processing by comparing the received information with the authentication information 57. When a login request including a user ID and a password is received from the device 20, the authentication managing unit 51 may perform user authentication processing by comparing the received information with the authentication information 57.

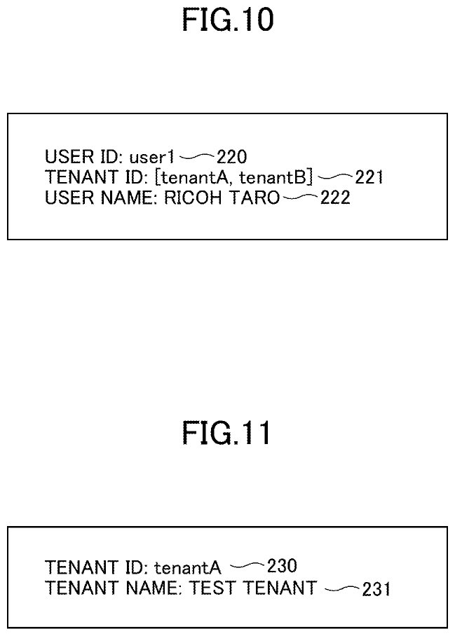

The user information storage unit 52 stores the user information 53. As illustrated in FIG. 10, the user information 53 includes the information of, for example, a user ID 220, a tenant ID 221 (the ID of the tenant to which the user belongs), and a user name 222. The user information storage unit 52 may include an e-mail address for each user. The user information can be added, edited, or deleted by the tenant administrator or the user by accessing the service providing system via the terminal apparatus 30.

The tenant information storage unit 54 stores the tenant information 55. As illustrated in FIG. 11, the tenant information 55 includes, for example, information of a tenant ID 230 and a tenant name 231. The tenant information may include information for identifying an application that is available for use by making a license contract for each tenant, information for identifying a user or the device 20 belonging to the tenant, and information for identifying a user or the device 20 for which the use of the application is allowed or prohibited with respect to each application available for use.

The authentication information storage unit 56 stores authentication information 57 such as an access token of a user or a device. The authentication information storage unit 56 may store a password for each tenant ID or user ID. The device information may be provided as information managed by the authentication managing unit. The device information includes information indicating, for example, the device ID, the tenant ID (the ID of the tenant to which the device 20 belongs), and the function or type of the device 20. The device information can be added, edited, or deleted by the tenant administrator or the user by accessing the service providing system via the terminal apparatus 30 or the device 20.

### <<Device>>

The device 20 includes a web browser 21. The web browser 21 includes a first communication unit 22, an operation accepting unit 23, and a display control unit 24, and downloads a program from the device web service processing unit 45. Each function is a function or means implemented by the CPU 901 by executing instructions included in one or more downloaded programs.

The first communication unit 22 transmits and receives information and the like relating to the application to and from the service providing system 10. The operation accepting unit 23 accepts various operations of a user in various screens displayed on the panel display unit 940a. Screen information is a program described in Hyper Text Markup Language (HTML), eXtensible Markup Language (XML), a script language, cascade style sheets (CSS), and the like. The configuration of the web page is mainly identified by HTML, the operation of a web page is defined by a script language, and the style of a web page is identified by CSS. The display control unit 24 interprets the screen information of various screens and displays the screen information on the panel display unit 940a.

### <<Terminal Apparatus>>

The terminal apparatus 30 includes a web browser 31. The web browser 31 includes a second communication unit 32, an operation accepting unit 33, and a display control unit 34, and downloads a program from the terminal web service processing unit 48. Each function is a function or means implemented by the CPU 501 by executing instructions included in one or more downloaded programs.

The second communication unit 32 transmits and receives information relating to the application to and from the service providing system 10. The operation accepting unit 33 accepts various operations of a user in various screens displayed on the display 506. Screen information is a program described in HTML, XML, script language, CSS, and the like. The configuration of the web page is mainly identified by HTML, the operation of a web page is defined by a script language, and the style of a web page is identified by CSS. The display control unit 34 interprets the screen information of various screens and displays the screen information on the display 506.

### <Process Flow>

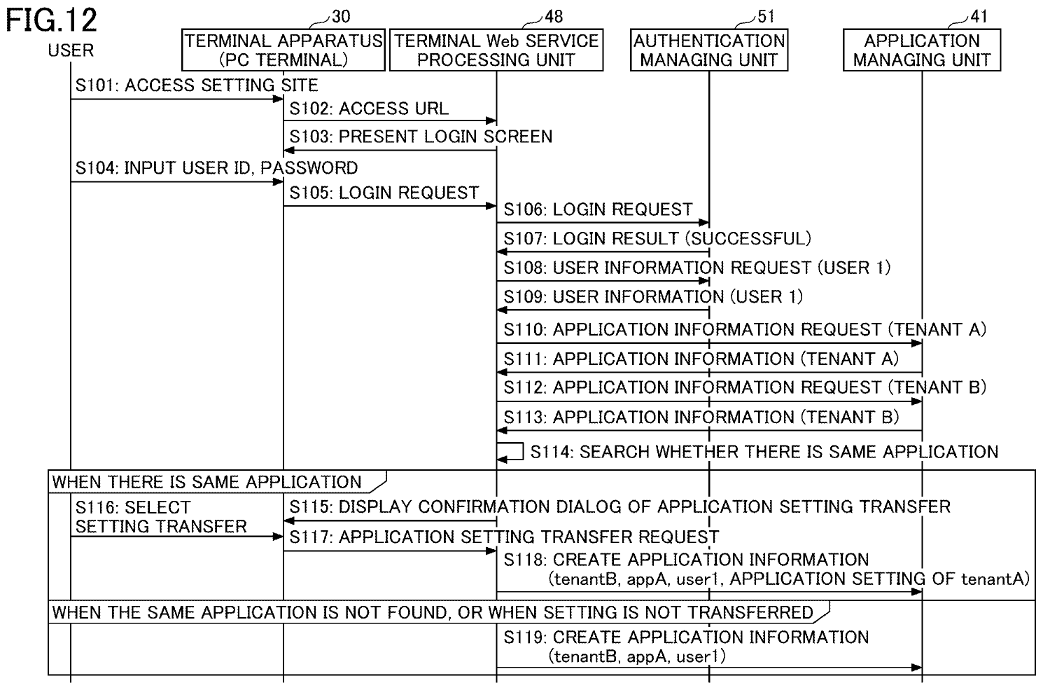

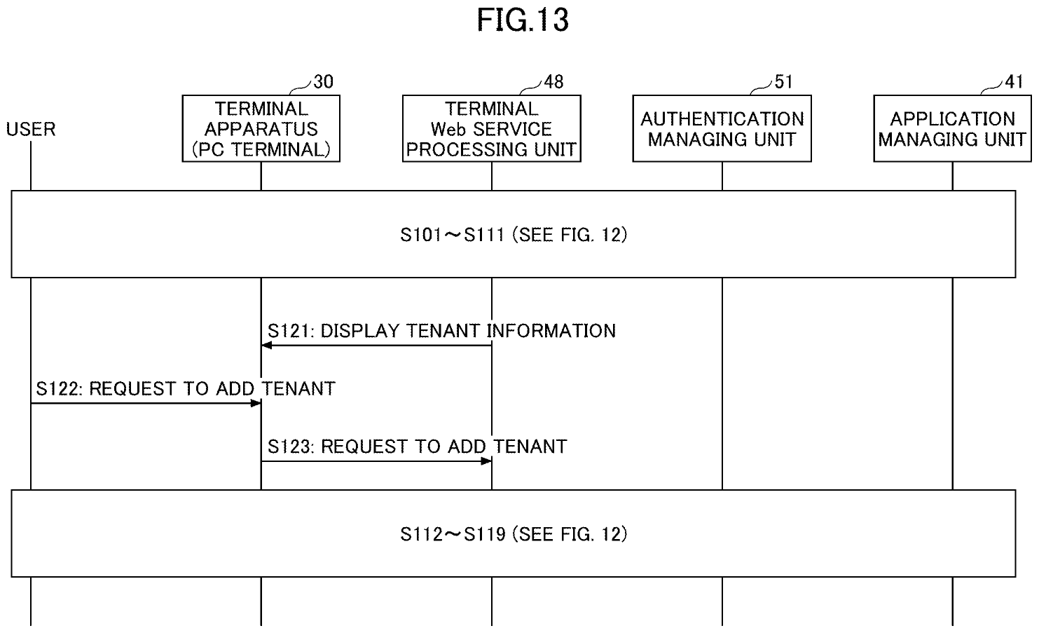

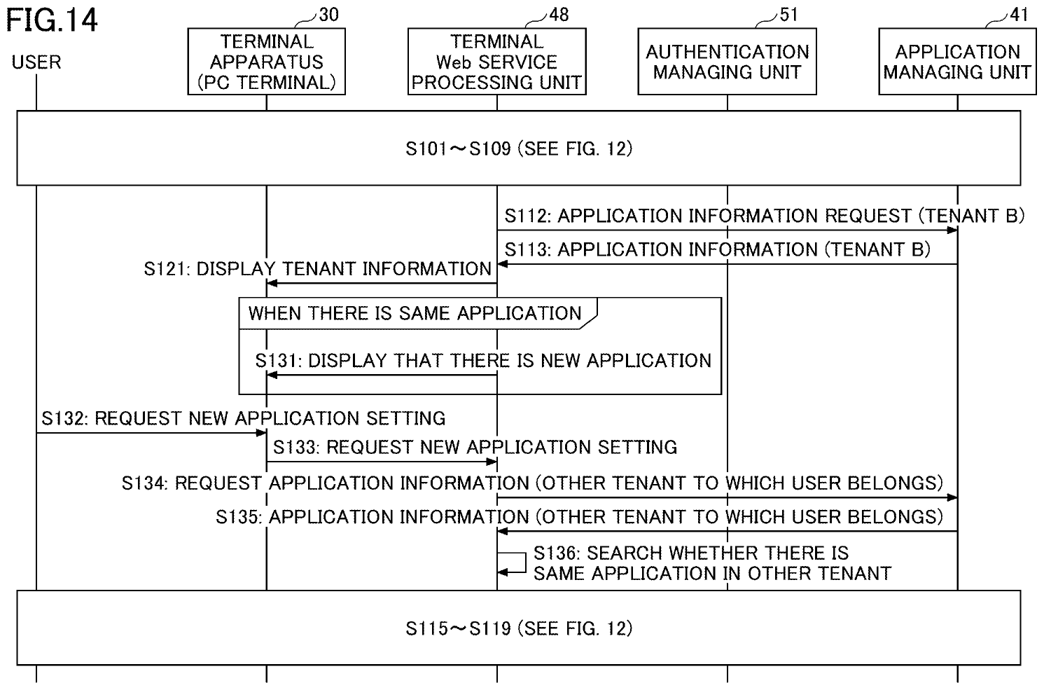

FIG. 12 is an example of a process of transferring an application setting when a user is added to a tenant. The administrator of the tenant B invites a user (user ID: user 1) belonging to the tenant A, to the tenant B. First, the administrator of the tenant B operates the management screen or the like of the tenant provided by the terminal web service processing unit 48, and the service providing system 10 transmits an invitation report e-mail to the user of the tenant A. In order to invite users, the tenant ID can be specified to target all users belonging to the corresponding tenant. Alternatively, only some users of a tenant can be selected, or the user ID or the user's e-mail address may be specified to directly specify the user. An invitation report e-mail is accompanied by information of the URL used for setting, with a link or the QR code (registered trademark) of the URL. Further, it is also possible to identify the tenant to which the user is invited, by embedding query information indicating the tenant to which the user is being invited, in the URL.

S101 and S102: The second communication unit 32 in the terminal apparatus 30 accesses the setting URL by using a link or a QR code of the URL attached to the e-mail received by the user from the operation accepting unit 33 in the terminal apparatus 30 when the user is invited to a tenant. Accordingly, the terminal web service processing unit 48 accepts a registration request to register the corresponding user to the tenant B.

S103: The image configurating unit 50 in the terminal web service processing unit 48 presents a login screen to the terminal apparatus 30. The display control unit 34 in the terminal apparatus 30 displays the login screen.

S104: The operation accepting unit 33 in the terminal apparatus 30 accepts a user ID (user 1) and a password input by the user.

S105: The second communication unit 32 in the terminal apparatus 30 transmits the user ID and the password to the terminal web service processing unit 48 to make a login request.

S106: The terminal web service processing unit 48 transmits the user ID and the password to the authentication managing unit 51 to make the login request.

S107: The authentication managing unit 51 transmits the result of the successful login to the terminal web service processing unit 48, upon confirming that the received login ID and the password match the authentication information 57 in the authentication information storage unit 56.

S108: The information acquiring unit 61 in the terminal web service processing unit 48 requests the authentication managing unit 51 to provide user information relating to which tenant the user belongs to.

S109: The authentication managing unit 51 acquires user information relating to which tenant the user belongs to, from the user information 53 stored in the user information storage unit 52, and transmits the acquired user information to the information acquiring unit 61 in the terminal web service processing unit 48. That is, the tenant ID corresponding to the tenant to which the logged-in user (user ID: user 1) has already belonged before receiving the invitation, is transmitted. Here, the user belongs to the tenant A, and, therefore, the tenant ID representing the tenant A is transmitted.

S110: The information acquiring unit 61 in the terminal web service processing unit 48 requests the application managing unit 41 to provide the application information relating to the tenant A. The application information includes information relating to the type of application available for use at the tenant A and the user's application setting.

S111: The application managing unit 41 acquires application information relating to the tenant A from the application information 66 stored in the application information storage unit 65 and transmits the acquired application information to the information acquiring unit 61 in the terminal web service processing unit 48.

S112: The information acquiring unit 61 in the terminal web service processing unit 48 requests the application managing unit 41 to provide the application information relating to the tenant B. That is, the information acquiring unit 61 requests for application information corresponding to the tenant to which the logged-in user (user ID: user 1) is invited. This application information includes information relating to the type of application available for use at the tenant B.

S113: The application managing unit 41 acquires application information relating to the tenant B from the application information 66 stored in the application information storage unit 65 and transmits the acquired application information to the information acquiring unit 61 in the terminal web service processing unit 48.

S114: The determining unit 62 in the terminal web service processing unit 48 searches whether there is an application (the same application) available for use to both the tenant A and the tenant B by using the application information of the tenant A and the tenant B acquired by the information acquiring unit 61. When there is the same application, the process proceeds to S115. When the same application is not found, the process proceeds to S119.

S115: (When there is the same application) The image configurating unit 47 in the terminal web service processing unit 48 creates a dialog screen for confirming whether to transfer the application setting and transmits the screen to the terminal apparatus 30. The display control unit 34 in the terminal apparatus 30 displays the received dialog screen. Here, it is assumed that the same application is an application A (app ID: appA).

S116: The user selects whether to transfer the application setting. The operation accepting unit 33 in the terminal apparatus 30 accepts the user's selection result.

S117: When the user selects to transfer the application setting, the second communication unit 32 in the terminal apparatus 30 transmits an application setting transfer request to the terminal web service processing unit 48. When the user does not select to transfer the application setting, the same process as in the case where the same application is not found, is performed by proceeding to S119.

S118: The setting creating unit 63 in the terminal web service processing unit 48 copies the application setting of the user of the former tenant (tenant A), to create the application setting of the user of the new tenant (tenant B). The terminal web service processing unit 48 transmits the tenant ID (tenantB), the application ID (appA), the user ID (user 1), and the created application setting to the application managing unit 41 and requests the creation of the application information of the new tenant (tenant B). The application managing unit 41 creates the application information of the tenant B based on the received application setting and stores the application information in the application information 66 of the application information storage unit 65.

S119: (When the same application is not found) The terminal web service processing unit 48 transmits the tenant ID (tenant B), the application ID (appA), and the user ID (user 1) to the application managing unit 41 without specifying an application setting, and requests the creation of the application information of the new tenant (tenant B). The application managing unit 41 creates the application setting of the tenant B by using an initial value which is stored in advance, and stores the created application setting in the application information 66 of the application information storage unit 65.

In this example, the transfer in the case of an individual application for which there is a setting for each user, is described. However, if the user has the right of an administrator, the setting can be transferred not only for the individual application but also for a shared application. In the case of the shared application, by displaying a screen to confirm whether to transfer the setting only when the application setting of the transfer source is different from the default value, the setting by the user can be simplified. Further, the terminal web service processing unit 48 may cause a user to input the application setting value and use the input result as the setting value to create the application setting.

<Process flow (Modification 1)>

FIG. 13 illustrates an example of an application setting transfer process when a user adds a tenant, as a modification of the present embodiment. In this modification, the user newly joins a tenant B, by adding another existing tenant (tenant B) from the setting screen of an existing tenant (tenant A).

S101 to S111: A user accesses a setting URL to add a tenant, from the terminal apparatus 30. The procedure is the same as that illustrated in FIG. 12, and, therefore, the description will be omitted.

S121: The terminal web service processing unit 48 transmits, to the terminal apparatus 30, information relating to a tenant that can be added by the user. The display control unit 34 in the terminal apparatus 30 displays the received information relating to the tenant.

S122: The user selects a tenant (tenant B) to be added from the tenants that can be added displayed on the terminal apparatus 30. The operation accepting unit 33 in the terminal apparatus 30 accepts the selection result.

S123: The second communication unit 32 in the terminal apparatus 30 transmits a request to add the tenant (tenant B) selected by the user, to the terminal web service processing unit 48.

S112 to S119: Similar to the case illustrated in FIG. 12, when there is the same application that is available for use in both the tenant A and the tenant B, upon confirming with the user about the setting transfer, the transfer of the application setting is executed.

### <Process Flow (Modification 2)>

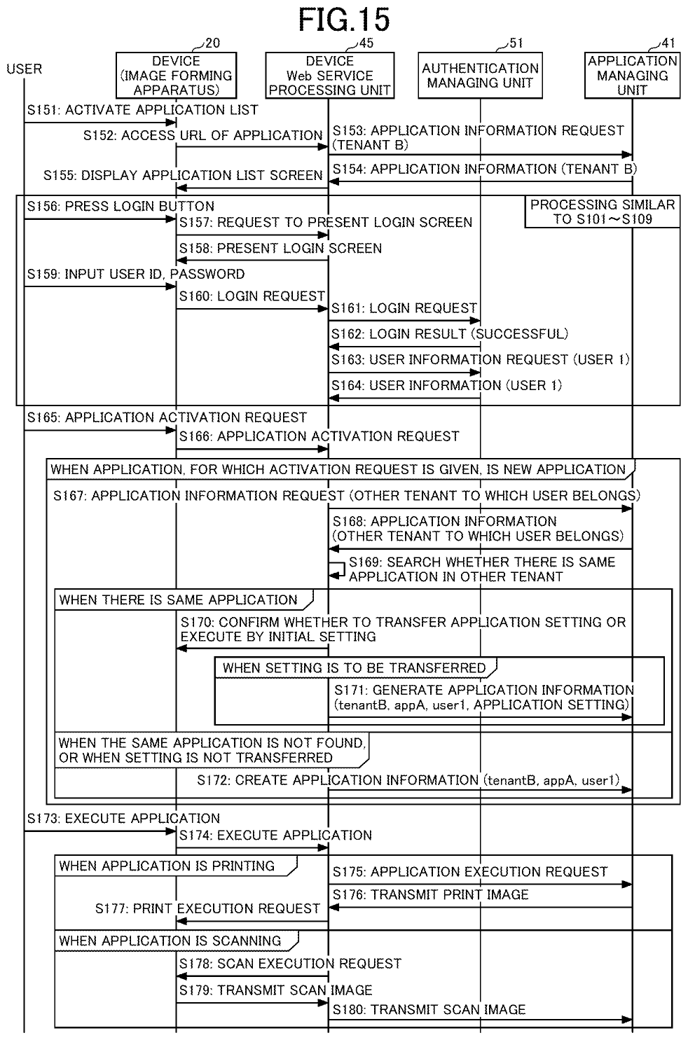

FIG. 14 illustrates an example of a process when an application (app ID: appA) is added in an environment of belonging to multiple tenants, as a modification of the present embodiment. If the tenant administrator has purchased an application license, a new application available for use to the tenant can be added. For example, when an administrator of the tenant B adds a new application that can be used by the tenant B, a user belonging to the tenant B and the tenant A can transfer the application setting set for the tenant A to the setting of the application newly added to the tenant B.

S101 to S109: The user accesses a setting URL from the terminal apparatus 30 to add a tenant. 1C The procedure is the same as that illustrated in FIG. 12.

S112 and S113: The terminal web service processing unit 48 acquires the application information of the tenant B according to the procedure illustrated in FIG. 12.

S121: In this modification, the user belongs to multiple tenants, and tenant information is displayed at the time of login. The information to be displayed may be information of a predetermined priority tenant (here, the tenant B) or information of all tenants. When the information of all tenants is displayed, the application information of other tenants to which the user belongs, is acquired immediately after the process of acquiring the application information of the tenant B. Specifically, the terminal web service processing unit 48 executes the processing of S134 to S135 after S113.

S131: The determining unit 62 in the terminal web service processing unit 48 confirms whether there is a new application that did not exist when the user logged in previously. That is, the determining unit 62 confirms whether there is a new application that the tenant administrator has added as an application that is available for use to the tenant, after the last time the user logged in via the terminal apparatus 30. The confirmation method is performed by confirming whether there is any information of an application available for use to the user in the acquired application information, and if there is corresponding information, it is determined that there is a new application. For example, if an application associated with the tenant ID of the tenant to which the logged-in user belongs is added to the application information, it may be determined that a new application exists. It is also possible to determine that a new application exists, when an application that has been allowed to be used by the logged-in user is added to the application information. When there is a new application, the image configurating unit 50 in the terminal web service processing unit 48 transmits information indicating that a new application exists to the terminal apparatus 30. The display control unit 34 in the terminal apparatus 30 displays that there is a new application.

S132: The user confirms the display and selects whether to make a setting of the new application. The operation accepting unit 33 in the terminal apparatus 30 accepts the selection result.

S133: When the user selects to make a setting of the new application, the terminal apparatus 30 transmits a new application setting request to the terminal web service processing unit 48.

S134: The information acquiring unit 61 in the terminal web service processing unit 48 requests the application managing unit 41 to provide application information of the tenant to which the user belongs other than the tenant B.

S135: The application managing unit 41 acquires application information of the tenant to which the user belongs other than the tenant B, from the application information 66 stored in the application information storage unit 65, and transmits the acquired application information to the information acquiring unit 61 in the terminal web service processing unit 48.

S136: The terminal web service processing unit 48 searches whether there is the same application in the tenant to which the user belongs other than the tenant B. If there is the same application, upon confirming with the user about the setting transfer, the transfer of the application setting is executed. Here, it is assumed that the tenant A has the same application. The procedure for transfer is the same as that illustrated in FIG. 12, and, therefore, the description will be omitted. If there is the same application in multiple tenants to which the user belongs, the user may choose which tenant's setting is to be transferred.

The example illustrated here is an example of an individual application, but in the case of a shared application, there is no application information for each user, and, therefore, in order to enable determination of whether the application is a new application, a flag indicating whether the application is a new application may be added in the application information.

### <Process Flow (Third Modification)>

FIG. 15 illustrates an example of a process when the application is activated without having a setting being made by the user at a setting site, as a modification of the present embodiment. In an environment in which a user belongs to multiple tenants, after an application (application ID: appA) is added to the tenant, the user does not access the setting site, and activates the application at an image forming apparatus, an electronic whiteboard, or the like, and transfers the application setting.

S151: The user activates an application for displaying an application list screen, by operating the operation accepting unit 23 in the device 20 that is the image forming apparatus associated with the tenant B.

S152: The first communication unit 22 in the device 20 accesses the URL of the application.

S153: The information acquiring unit 58 in the device web service processing unit 45 requests the application managing unit 41 to provide the application information relating to the tenant B. This application information includes information relating to the type of application available for use to the tenant B and the user's application setting.

S154: The application managing unit 41 acquires application information relating to the tenant B from the application information 66 stored in the application information storage unit 65 and transmits the acquired application information to the information acquiring unit 58 in the terminal web service processing unit 48.

S155: The device web service processing unit 45 transmits the information displaying the application list to be displayed to the user, to the device 20, by using the received application information relating to the tenant B. The display control unit 24 in the device 20 displays the application list.

S156: The user needs to log in to activate the personal application. Therefore, by operating the operation accepting unit 23 in the device 20, the user presses the displayed login button.

S157: The first communication unit 22 in the device 20 transmits a login screen presentation request to the device web service processing unit 45.

S158: The image configurating unit 47 in the device web service processing unit 45 presents the login screen to the device 20. The display control unit 24 in the device 20 displays the login screen.

S159: The operation accepting unit 23 in the device 20 accepts the user ID (user1) and password input by the user.

S160: The first communication unit 22 in the device 20 transmits the user ID and the password to the device web service processing unit 45 to make a login request.

S161: The device web service processing unit 45 transmits the user ID and the password to the authentication managing unit 51 and makes a login request.

S162: When it is confirmed that the received login ID and the password match the authentication information 57 of the authentication information storage unit 56, the authentication managing unit 51 transmits the result of the successful login to the device web service processing unit 45.

S163: The information acquiring unit 58 in the device web service processing unit 45 requests the authentication managing unit 51 to provide user information relating to which tenant the user belongs to.

S164: The authentication managing unit 51 acquires user information relating to which tenant the user belongs to, from the user information 53 stored in the user information storage unit 52, and transmits the acquired user information to the information acquiring unit 58 in the device web service processing unit 45.

S165: The user operates the operation accepting unit 23 in the device 20 to select an application to be activated from the displayed list of applications, and to request activation of the selected application.

S166: The first communication unit 22 in the device 20 transmits the request to activate the application selected by the user, to the device web service processing unit 45. The device web service processing unit 45 determines whether the application for which the activation request is given, is a new application. That is, the device web service processing unit 45 confirms whether the application is a new application added by the tenant administrator as an application available for use at the tenant, after the user last logged in via the device 20 or the terminal apparatus 30. The determination method is the same as that described in S131.

S167: In the case where the application for which the activation request is given, is a newly added application, as in the example of FIG. 14, upon confirming with the user about the setting transfer, the transfer of the application setting is executed. The information acquiring unit 58 in the device web service processing unit 45 requests the application managing unit 41 to provide the application information of the tenant to which the user belongs other than the tenant B.

S168: The application managing unit 41 acquires application information of a tenant to which a user belongs other than the tenant B, from the application information 66 stored in the application information storage unit 65, and transmits the acquired application information to the information acquiring unit 58 in the device web service processing unit 45.

S169: The determining unit 59 in the device web service processing unit 45 searches whether a tenant to which the user belongs other than the tenant B has the same application as the tenant B, by using the application information of the tenant acquired by the information acquiring unit 58. Here, it is assumed that the tenant A has the same application.

S170: When the same application exists, the device web service processing unit 45 displays a dialog for confirming about the application setting transfer, on the device 20.

S171: (When the setting is to be transferred) The setting creating unit 60 in the device web service processing unit 45 copies the application setting of user of the original tenant to create the application setting of the user of the new tenant (tenant B). The device web service processing unit 45 transmits the tenant ID (tenantB), the application ID (appA), the user ID (user 1), and the created application setting to the application managing unit 41 and requests the creation of the application information of the new tenant. The application managing unit 41 creates the application information of the tenant B based on the received application setting and stores the application information in the application information 66 of the application information storage unit 65.

S172: (When the setting is not to be transferred) The device web service processing unit 45 transmits the tenant ID (tenant B), the application ID (appA), and the user ID (user 1) to the application managing unit 41 without specifying the application setting, and requests the creation of the application information of the new tenant. The application managing unit 41 creates an application setting of a new tenant by using the initial value which is stored in advance, and stores the application setting in the application information 66 of the application information storage unit 65.

S173: The user operates the operation accepting unit 23 in the device 20 to execute the application for which the application setting is completed.

S174: The first communication unit 22 in the device 20 transmits an application execution request to the device web service processing unit 45. When the application is related to a printing process, the processing of S175 to S177 is executed. When the application is related to a scanning process, the processing of S178 to S180 is executed. Here, before transmitting the application execution request, the device 20 may send a query to the application managing unit to inquire about the application setting, and display, on the operation accepting unit 23, the processing condition according to the application based on the acquired application setting. For example, in the case where the application is related to a printing process, a list of files stored in the cloud storage may be displayed based on the information of the “origin folder” included in the application setting, and a selection of the desired print target file may be accepted. Further, the user can change the printing condition included in the application setting if necessary, by operating the operation accepting unit 23. When the application is related to a scanning process, a list of folders stored in the cloud storage may be displayed based on the information of the “origin folder” included in the application setting, and a selection of the desired folder may be accepted as the destination for storing the scan data. The user can change the scan condition included in the application setting if necessary, by operating the operation accepting unit 23.

S175: (When the application is printing) The device web service processing unit 45 transmits an application execution request to the application managing unit 41.

S176: The application managing unit 41 transmits the image to be printed to the device web service processing unit 45.

S177: The device web service processing unit 45 transmits the received image to the device 20 and requests the device 20 to request the execution of printing. Here, when the file to be printed is stored in the cloud storage, the service providing system downloads the file to be printed from the cloud storage, performs processing as required, and then transmits the file to the device 20 to request the execution of printing.

S178: (When the application scanning) The device web service processing unit 45 requests the device 20 to execute the scanning.

S179: The device 20 executes scanning and transmits the scanned image to the device web service processing unit 45.

S180: The device web service processing unit 45 transmits the received image to the application managing unit 41. Here, when cloud storage is specified as the storage destination of the scan data, the service providing system performs the desired processing on the scan data, and then uploads the scan data to be stored in the folder of the cloud storage.

In the present embodiment, a description is given of the process of transferring the application setting of another tenant when a user is invited to be a user of a tenant, but the present embodiment is not limited thereto. For example, it may be assumed that multiple groups are created in a tenant and applications that are available for use are set for each group. In such a case also, by executing the same sequence as that illustrated in FIGS. 12 to 14, it is possible to transfer the application setting of the user invited to another group, from the group to which the user already belongs.

### <Major Effects>

As described above, in the service providing system 10 according to the present embodiment, it is possible to transfer the application setting when a user or an application is added to another tenant, and, therefore, there is an effect of reducing the initial setting operation for the application.

### Second Embodiment

Next, a second embodiment according to the present embodiment will be described. In the present embodiment, in addition to the case where a user who has already belonged to a tenant is newly belonging to another tenant, even in a case when a user who has not yet belonged to any tenant is newly belonging to a tenant, it is considered that the creation of a new application setting can be omitted. Each tenant has a template for each application setting. This template describes which item of the user information is to be used for each item of application setting. Accordingly, when a user is added, by adding the value of the necessary item of the user information to the template, the application setting can be automatically generated. For example, it may be described in the template to use the value of the user ID as the name of the folder for storing the file after the scan is executed. Further, it may be described in the template to use the e-mail address of the user described in the user information, as the e-mail transmission destination of the scanned file. In this way, the template may be created in accordance with the rules for creating folder names in the organization, etc., thereby enabling highly convenient operations.

In the present embodiment, the elements having the same reference numerals as those of the first embodiment perform the same functions. Therefore, only the main elements of the present embodiment will be described. The system configuration is the same as that illustrated in FIG. 1.

### <Operation Overview>

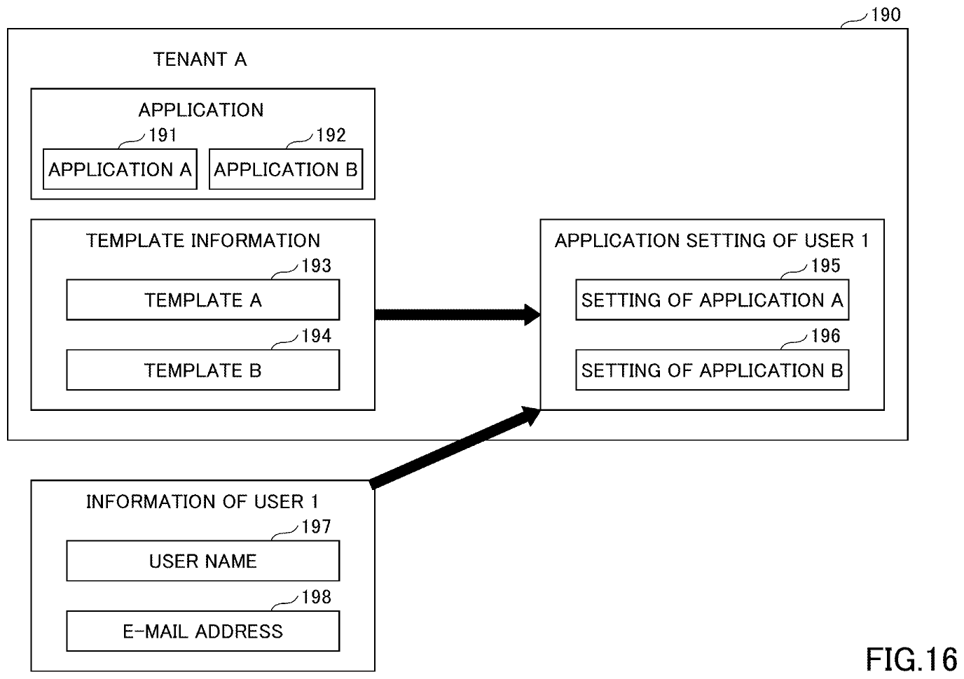

An outline of the operation performed by the service providing system according to the present embodiment will be described with reference to FIG. 16. In a tenant A 190, two applications, i.e., an application A 191 and an application B 192 are available for use, and these applications respectively have a template A193 and a template B 194 as template information. Here, when the user 1 is added to the tenant A, the setting creating unit 63 of the terminal web service processing unit 48 creates a setting 195 of the app A and a setting 196 of the app B, which are the settings of the user 1, by using the values of a user name 197 and an e-mail address 198, which are the user information of the user 1, with respect to the template information.

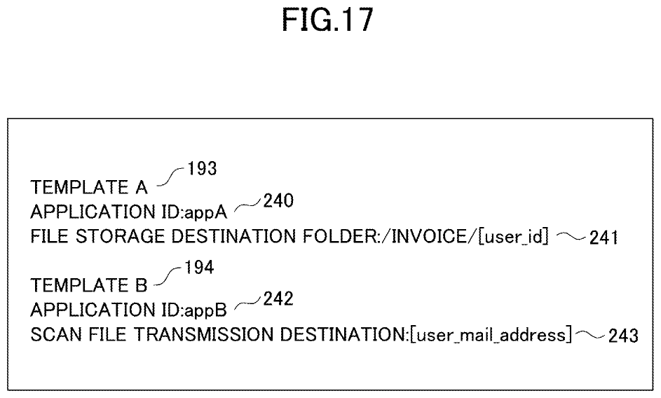

FIG. 17 illustrates an example of template information. The application ID 240 in the template A 193 is appA, and, therefore, as a file storage destination folder 241 for the application A, /invoice/[user_id] is set. Here, the user ID of user 1 is set to [user_id]. That is, the file storage destination becomes the folder having the folder name corresponding to the user ID of user 1, that is in the lower layer of the folder having the folder name “invoice”. With respect to the creation of the storage destination, the external service cooperation unit 64 may request the creation of a folder when the service providing system 10 transmits scan data to a server such as the cloud storage corresponding to the app A, or the external service cooperation unit 64 may request the creation of a folder in advance before the scanning is executed.

Here, when creating a folder, the external service cooperation unit 64 requests a server such as a cloud storage to create a folder with the folder name corresponding to the user ID. On the other hand, the application ID 242 of the template B 194 is app B, and, therefore, for the application B, [user_mail_address] is set as a scan file transmission destination 243. Here, in [user_mail_address], the e-mail address of the user 1 is set.

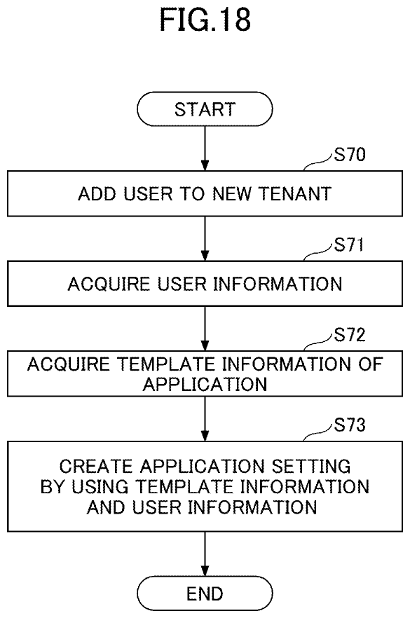

Next, a process flow performed by the service providing system according to the second embodiment will be described with reference to FIG. 18.

S70: The tenant administrator adds a user to a new tenant. The user may be a user who already belongs to another tenant or a user who does not belong to any tenant.

S71: The authentication managing unit 51 acquires user information. When the user information is already registered in the user information storage unit 52, the authentication managing unit 51 acquires the user information. When the user information is not registered in the user information storage unit 52, for example, the authentication managing unit 51 accepts the input of the user information, such as the user name or the e-mail address, from the user via the terminal apparatus 30.

S72: The application managing unit 41 acquires the template information of the application.

S73: The application managing unit 41 creates an application setting by using the template information and the user information.

### <Functions>

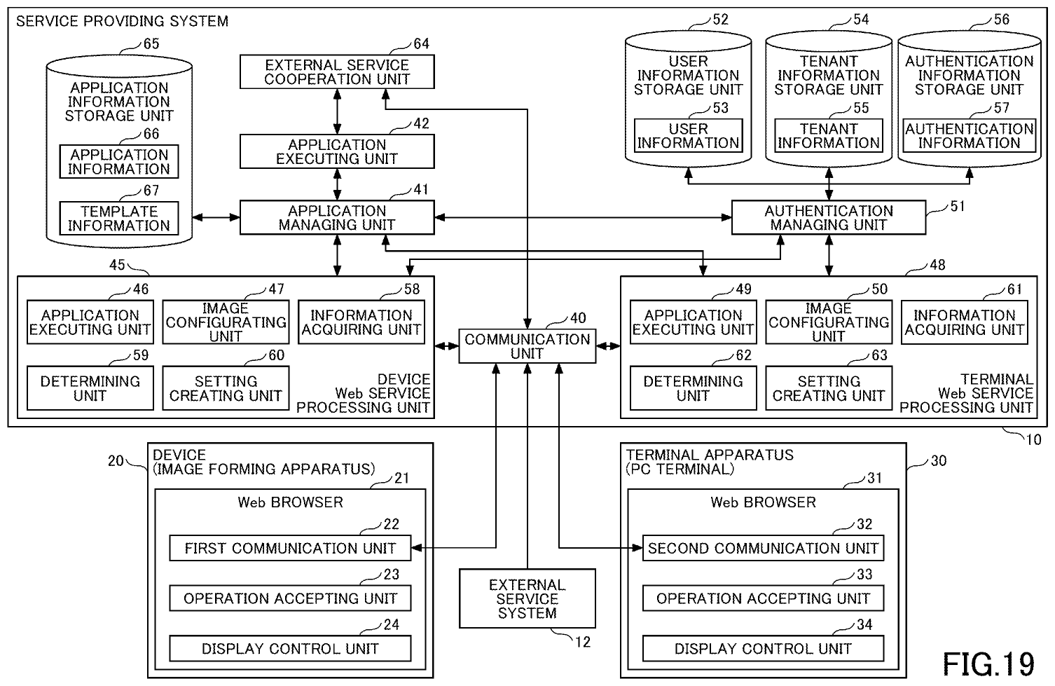

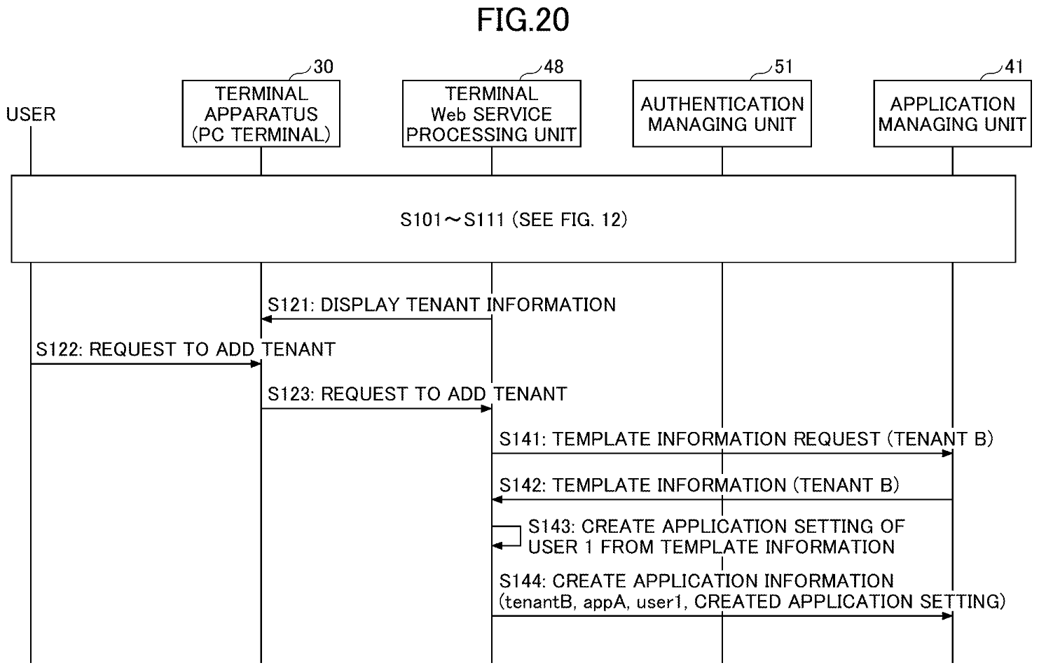

FIG. 19 illustrates the functional configuration of the service providing system 10 according to the second embodiment. The difference from the service providing system 10 according to the first embodiment illustrated in FIG. 7 is only that template information 67 is added to the application information storage unit 65. For example, a tenant administrator can access the service providing system via a terminal apparatus to create and store template information. The template information may be created for each application, but may be created as common template information among multiple applications.

### <Process Flow>

FIG. 20 illustrates an example of an application setting transfer process when adding a tenant by using the template information 67.

The processing of S101 to S111 and S121 to S123 are the same as those of the modification 2 of the first embodiment illustrated in FIGS. 12 and 13.

S141: The information acquiring unit 61 in the terminal web service processing unit 48 requests the application managing unit 41 to provide the template information 67 of the tenant B.

S142: The application managing unit 41 transmits the template information 67 of the tenant B to the information acquiring unit 61 in the terminal web service processing unit 48.

S143: The setting creating unit 63 of the terminal web service processing unit 48 creates the application setting of the application A by using the received template information 67 of the tenant B and the user information of the user 1.

S144: The terminal web service processing unit 48 transmits the tenant ID (tenantB) of the tenant for which the application setting is to be created, the application ID (appA) for which the application setting is to be created, the user ID (user 1), and the created application setting to the application managing unit 41 and requests the creation of the application information of the tenant B.

When the user already belongs to the tenant A, the terminal web service processing unit 48 may create the application setting in the tenant B based on the application setting value of the tenant A and the template information 67 of the tenant B. For example, when there is the same application in both the tenant A and the tenant B, only the setting items that are not defined in the template information among the setting items included in the application setting of the corresponding application, may be transferred from the application setting value of the tenant A. Further, when there are setting items included in the application setting of the tenant A and setting items that are defined in the template information, with respect to such setting items, the setting item values created based on the template information may be preferentially set.

### <Major Effects>

As described above, by using the template information of the application setting, even when a user who does not already belong to a tenant is to newly belong to a tenant, the creation of a new application setting can be omitted.

Although some embodiments of the present invention have been described, the service providing system, the information processing method, and the recording medium are not limited to the specific embodiments described in the detailed description, and variations and substitutions may be made without departing from the spirit and scope of the present invention.

For example, the configuration examples of FIGS. 7 and 19 are divided according to the main functions to facilitate the understanding of processes by the terminal apparatus 30, the device 20, and the service providing system 10. The present invention is not limited by how the process units are divided or the names of the process units. The processes of the terminal apparatus 30, the device 20, and the service providing system 10 may be further divided into many process units according to the process contents. Furthermore, the process units may be divided such that a single process unit further includes many processes.

The functions of each of the embodiments described above may be implemented by one or more processing circuits. As used herein, a “processing circuit” includes a processor programmed to execute each function by software such as a processor implemented in an electronic circuit; or devices such as an Application Specific Integrated Circuit (ASIC), a digital signal processor (DSP), a field programmable gate array (FPGA), and a conventional circuit module, designed to execute each function as described above.

Also, the apparatus group described in the examples are merely indicative of one of a plurality of computing environments for carrying out the embodiments disclosed herein. In some embodiments, the servicing providing system includes a plurality of computing devices, such as server clusters. The plurality of computing devices are configured to communicate with each other via any type of communication link, including networks, a shared memory, and the like, and perform the processes disclosed herein.

The device 20 is not limited to an image forming apparatus, as long as a communication function is included. The device 20 may be, for example, a Projector (PJ), an Interactive White Board (IWB, a whiteboard having a blackboard function capable of mutual communication), an output device such as a digital signage, a Head Up Display (HUD) device, an industrial machine, an imaging device, a sound collector, a medical device, a network appliance, a connected car, a notebook personal computer (PC), a mobile phone, a smartphone, a tablet terminal, a game machine, a Personal Digital Assistant (PDA), a digital camera, a wearable PC, a desktop PC, and the like. Further, when a user belonging to the tenant A is invited to the tenant B, the user can belong to both the tenant A and the tenant B. At this time, when the user uses the device 20, by logging in to either the tenant A or the tenant B, only an application that is available for use to the tenant A or the tenant B can be used. Here, whether the user logs in to the tenant A or the tenant B may be specified by setting a priority tenant in advance or by selecting a tenant or inputting the tenant ID at the time of login. However, the embodiment is not limited thereto, and when the user is registered to the tenant B, the user's registration may be deleted from the tenant A. Further, when both the tenant A and the tenant B are used continuously, every time there is a change in the setting of one tenant, the setting in the other tenant may be changed in a synchronized manner. For example, there are cases where a user 1 who belonged to the tenant A is invited to the tenant B and may belong to both the tenant A and the tenant B. In this case, the service providing system stores information indicating that the application setting in the tenant A of user 1 has been transferred to the tenant B. When the application setting of the tenant A or the tenant B of the user 1 is changed, the application setting of the other tenant can be changed in the same manner.

According to one embodiment of the present invention, a setting of an application that is used in a second managing unit can be created based on a setting of the application that is also available for use in a first managing unit in which the user is already registered.

What is claimed is:

1. A service providing system configured to manage information relating to an application that is available for use to a user in a management unit in which the user is registered, the service providing system comprising:
circuitry; and
a memory storing computer-executable instructions that cause the circuitry to execute:
creating a setting of an application that is available for use in a second management unit, based on a setting of the application that is also available for use in a first management unit in which the user is already registered, in response to a registration request to register the user in the second management unit.

2. The service providing system according to claim 1, wherein the circuitry is further caused to execute:
determining whether the application that is available for use in the first management unit, is also available for use in the second management unit.

3. The service providing system according to claim 2, wherein
in response to a new application being added to a management unit among a plurality of management units to which the user belongs,
the determining includes determining whether the new application is also available for use in another management unit among the plurality of management units to which the user belongs, other than the management unit to which the new application has been added, and
the creating includes creating a setting of the new application at the management unit to which the new application has been added, by using a setting of the new application at the another management unit that is determined to be where the new application is also available for use.

4. The service providing system according to claim 1, wherein the creating of the setting of the application includes creating the setting of a new application by using template information of the setting of the application included in the first management unit to which the user belongs.

5. The service providing system according to claim 1, wherein the circuitry is further caused to execute:
receiving a selection result of a selection made by the user as to whether the setting of the application of the first management unit is to be used to create the setting of the application of the second management unit, wherein
the creating includes creating the setting of the application of the second management unit based on the selection result.

6. The service providing system according to claim 1, wherein the circuitry is further caused to execute:
receiving an input result of an input performed by the user with respect to at least one setting item in the setting of the application, wherein
the creating includes creating the setting of the application based on the input result.

7. The service providing system according to claim 1, wherein the creating includes creating the setting of the application, in response to accepting login to the service providing system by the user for a first time, after the user is registered in the second management unit.

8. An information processing method performed by an information processing apparatus configured to manage information relating to an application that is available for use to a user in a management unit in which the user is registered, the information processing method comprising:
creating a setting of an application that is available for use in a second management unit, based on a setting of the application that is also available for use in a first management unit in which the user is already registered, in response to a registration request to register the user in the second management unit; and
executing a function provided by the application based on the setting.

9. A non-transitory computer-readable recording medium storing a program that causes a computer to execute a process performed in an information processing apparatus configured to manage information relating to an application that is available for use to a user in a management unit in which the user is registered, the process comprising:
creating a setting of an application in a second management unit to which the user is to newly belong, by using a setting of the application in a first management unit to which the user already belongs, in response to a registration request to register the user in the second management unit.
